(19) United States
(12) Patent Application Publication
(10) Pub. No.: US 2011/0072678 A1
(43) Pub. Date: Mar. 31, 2011

(54) Composite Machine For Drying Dishes And Cleaning Vegetables And Fruits

(76) Inventor: Kuei-Tang CHANG, Banchiau City (TW)

(21) Appl. No.: 12/570,036

(22) Filed: Sep. 30, 2009

(51) Int. Cl. F26B 19/00; A23N 12/00

(52) U.S. Cl. 34/91; 99/516

(57) ABSTRACT

A composite machine for drying dishes and cleaning vegetables and fruits includes a dish-drying body, an ozone generator, a cover and a switching element. The cover selectively covers the dishes or allows the vegetables and fruits to be received therein. The switching element is switchable to be electrically connected to the dish-drying body or the ozone generator. The dish-drying body generates hot air to dry the dishes when the switching element is electrically connected to the dish-drying body. The ozone generator generates ozone to clean the vegetables and fruits when the switching element is electrically connected to the ozone generator. With this arrangement, the operation of drying dishes or cleaning vegetables and fruits can be executed as demands. Thus, the utility rate of the machine is increased and the space can be used more effectively. As a result, the cost is reduced and the maintenance is easy.

### BACKGROUND OF THE INVENTION

1. Field of the Invention

The present invention relates to a dish-drying and vegetable-cleaning machine, and in particular to a composite machine capable of generating hot air for drying dishes and ozone for cleaning vegetables and fruits.

2. Description of Prior Art

A dish dryer is a common electric appliance used in the kitchen of a house. The dish dryer is used to dry tableware such as bowls, dishes or the like. If the dishes after washing are not dried completely, the water droplets on the surface of the dishes may wet the environment. As a result, bacteria may propagate to generate mildew. Since the dishes are utensils for containing foods, if the dishes are not cleaned, it may be harmful to the human's body. Thus, the tableware such as bowls and dishes has to be disposed on a dish rack within the dish dryer and the water droplets on the bowls and dishes are dried by hot air, thereby keeping the environment dried and preventing the propagation of bacteria. A common dish dryer includes a machine body, an outer cover for covering the machine body, and a dish rack. A closed space is formed between the outer cover and the machine body for receiving the dishes. An electric heater is provided in the machine body. The hot air generated by the electric heater is circulated in the closed space, whereby the tableware can be sterilized and dried quickly. In this way, clean and sterilized tableware can be used, and the operation of this dish dryer is very convenient. Usually, the tableware is washed in a cleaning trough. As a result, the dish dryer is arranged near the cleaning trough, so that it is convenient for the user to put the washed tableware in the nearby dish dryer for drying. The water droplets collected from the tableware can be drained in the cleaning trough. However, when the dish dryer is not in use, it occupies a lot of space, which is really a problem.

As for the vegetables, not only the freshness, but also the cleanness is needed. Especially, the vegetables and fruits used for uncooked vegetable salad including leaf vegetables (e.g. parsley, spinach), fruit vegetables (e.g. tomato, cucumber) or fruits (muskmelon, apple), since these vegetables and fruits are eaten uncooked, no sweat dirt, insect eggs or pesticide can remain on the surfaces of the vegetables and fruits. The original way of cleaning the vegetables is as follows: vegetables are first received in a vegetable basket and the vegetable basket is dipped into the water of the cleaning trough, so that the flowing water rinses away the sweat dirt, insect eggs and remaining pesticide on the surfaces of the vegetables. Alternatively, a machine is developed for cleaning vegetables, which includes a body with an open top surface, and a water-stirring tray provided in the bottom of the body. Water is filled in the body and the vegetables and fruits are put in an upper portion of the body. The water-stirring tray is powered to stir the water, whereby the whirling water can clean the vegetables and fruits. However, using the flowing water in the cleaning trough to rinse the vegetables and fruits needs a lot of water, which causes the increase in the cost. On the other hand, the vegetable-cleaning machine has a lot of components and is complicated in structure, which also raises the cost and the subsequent maintenance.

Therefore, in order to solve the above-mentioned problems, the present Inventor proposes a reasonable and novel structure based on his deliberate research and expert experiences.

### SUMMARY OF THE INVENTION

The present invention is to provide a composite machine for drying dishes and cleaning vegetables and fruits, thereby drying dishes or cleaning vegetables and fruits by ozone. With this arrangement, the utility rate of the machine can be increased, and the space can be used more effectively. Further, the cost can be reduced and the maintenance is easy.

The present invention provides a composite machine for drying dishes and cleaning vegetables and fruits, which includes a dish-drying body; an ozone generator mounted in the dish-drying body, the ozone generator having an air-delivering pipe; and a cover selectively covering the dishes or allowing the vegetables and fruits to be received therein, one end of the air-delivering pipe being disposed in the cover.

The present invention provides a composite machine for drying dishes and cleaning vegetables and fruits, which includes a dish-drying body; an ozone generator mounted in the dish-drying body, the ozone generator having an air-delivering pipe; a cover selectively covering the dishes or allowing the vegetables and fruits to be received therein, one end of the air-delivering pipe being disposed in the cover; and a switching element fixed in the dish-drying body and switchable to be electrically connected to the dish-drying body or the ozone generator, wherein the dish-drying body generates hot air to dry the dishes when the switching element is electrically connected to the dish-drying body, and the ozone generator generates ozone to clean the vegetables and fruits when the switching element is electrically connected to the ozone generator.

The present invention provides a composite machine for drying dishes and cleaning vegetables and fruits, which includes a dish-drying body for allowing the dishes or the vegetables and fruits to be disposed therein; an ozone generator mounted in the dish-drying body, the ozone generator having an air-delivering pipe; and a switching element fixed to the dish-drying body and switchable to be electrically connected to the dish-drying body or the ozone generator, wherein the dish-drying body generates hot air to dry the dishes when the switching element is electrically connected to the dish-drying body, and the ozone generator generates ozone to clean the vegetables and fruits when the switching element is electrically connected to the ozone generator.

The present invention has advantageous features as follows. After washing, the water droplets on the dishes are dried by the hot air to keep the environment clean and prevent the propagation of bacteria. When the dish dryer is not in use, it can also generate ozone to clean the vegetables and fruits. Thus, the idle time of the composite machine is reduced, thereby increasing the utility rate and the using the space more effectively. With the strong sterilizing effect of the ozone, the ozone is dissolved in the water to remove the dirt and bacteria remaining on the vegetables and fruits. Thus, it is unnecessary to use a conventional machine of a complicated structure to clean the vegetables and fruits, so that the cost can be reduced and the maintenance is easy.

### BRIEF DESCRIPTION OF THE DRAWINGS

FIG. 1 is an exploded perspective view of the present invention;

FIG. 2 is a schematic view showing the operating state of the present invention in drying dishes;

FIG. 3 is a schematic view showing the operating state of the present invention in washing vegetables and fruits;

FIG. 4 is a view showing the introduction of ozone by a plurality of pipes in the present invention; and

FIG. 5 is a view showing the storage of the air-delivering pipe according to another embodiment of the present invention.

### DETAILED DESCRIPTION OF THE INVENTION

The characteristics and technical contents of the present invention will be described with reference to the accompanying drawings. However, the drawings are illustrative only but not used to limit the present invention.

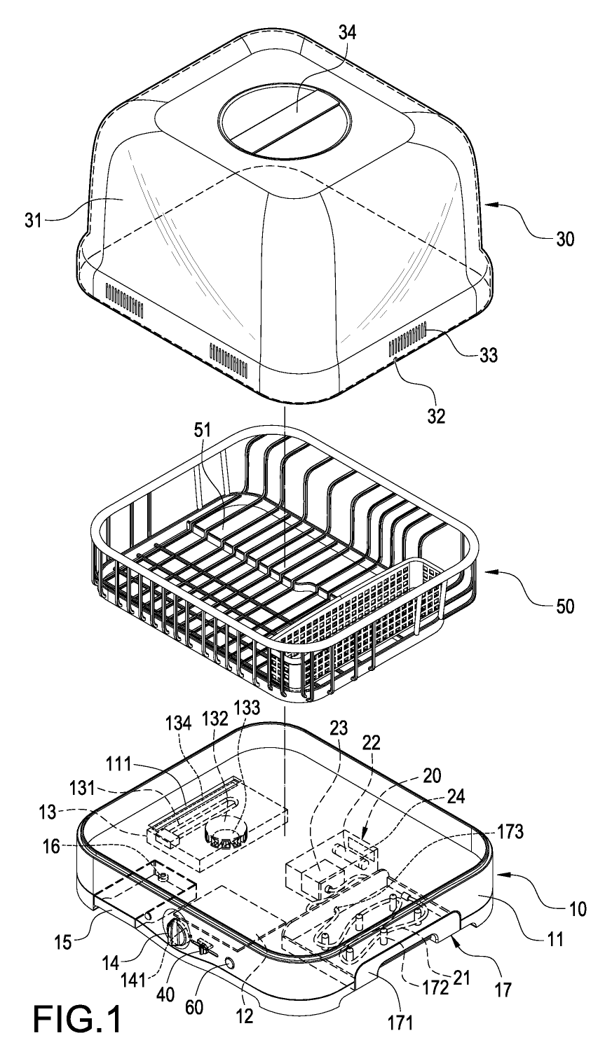

Please refer to FIG. 1, which is an exploded perspective view of the present invention. The present invention provides a composite machine for drying dishes and cleaning vegetables and fruits, which includes a dish-drying body 10, an ozone generator 20, a cover 30, a switching element 40, a tableware basket 50 and a switch 60.

The dish-drying body 10 includes a base 11, a circuit board 12, a hot air generator 13, a timer 14, a supporting tray 15, a drainage valve 16 and a storage portion 17. The circuit board 12 is fixed in the base 11 and electrically connected to an external power source. The hot air 13 is fixed in the base 11 and electrically connected to the circuit board 12. The internal components of the hot air generator 13 comprise a heating element 131 and a fan 132 for blowing the heating element 131. The hot air generator 13 is provided with an air-introducing port 133 located at one side near the fan 132 and an air-exiting port 134 located at one side near the heating element 131. The surface of the base 11 is provided with a hot air port 111 in communication with the air-exiting port 134. The timer 14 is exposed to the front surface of the base 11 and electrically connected to the circuit board 12. The supporting tray 15 is movably received in the base 11. The drainage valve 16 is provided in the base 11 to correspond to the position of the supporting tray 15. The storage portion 17 is movably provided in the base 11. The storage portion 17 comprises a plate 171 and a plurality of posts 172 protruding from the surface of the plate 171.

The ozone generator 20 is fixed in the base 11 to correspond to the storage portion 17 and electrically connected to the circuit board 12. The internal components of the ozone generator 20 comprise an air-delivering pipe 21, an ultraviolet lamp 22, and a cylinder 23. The ozone generator 20 is provided with a venting port 24 located at one side near the ultraviolet lamp 22. The cylinder 23 is positioned to correspond to the ultraviolet lamp 22 and away from the venting port 24. One end of the air-delivering pipe 21 is connected to the cylinder 23. The storage portion 17 is provided with a guiding hole 173 at one side near the cylinder 23. The other end of the air-delivering pipe 21 penetrates the guiding hole 173 to be wound around the posts 172, so that a certain length of the air-delivering pipe 21 can be wound around the plate 171.

The cover 30 is made of transparent materials and provided on the dish-drying body 10. The cover 30 has an accommodating space 31. A lower portion of the periphery of the cover 30 is provided with an insertion hole 32 and a plurality of exhausting holes 33. The surface of the cover 30 is formed with a handle 34. The end of the air-delivering pipe 21 away from the cylinder 23 penetrates the insertion hole 32 and is disposed in the accommodating space 31.

The switching element 40 is exposed to the front surface of the base 11 and electrically connected to the circuit board 12. The switching element 40 is switchable to be electrically connected to the dish-drying body 10 and the circuit board 12 or electrically connected to the ozone generator 20 and the circuit board 12. When the switching element 40 is electrically connected to the dish-drying body 10, the dish-drying body 10 generates hot air. When the switching element 40 is electrically connected to the ozone generator 20, the ozone generator 20 generates ozone.

In addition to be switchable between the above-mentioned target components, the switching element 40 can also restrict the countdown time of the timer 14. The bottom of a knob of the timer 14 has a cam structure 141. When the switching element 40 is switched to the dish-drying function, the cam structure 141 can rotate freely without any restriction, and the timer 14 can be set arbitrarily. When the switching element 141 is switched to the ozone-cleaning function, the switching element 40 will restrict the rotation of the cam structure 141, so that the timer 14 can be only set to a certain value.

The tableware basket 50 is provided on the dish-drying body 10 and received in the accommodating space 31. The tableware basket 50 has a plurality of filtering holes 51.

The switch 60 is exposed to the front surface of the base 11 and electrically connected to the circuit board 12. The switch 60 is used to turn on or off the electrical connection between the circuit board 12 and the external power supply.

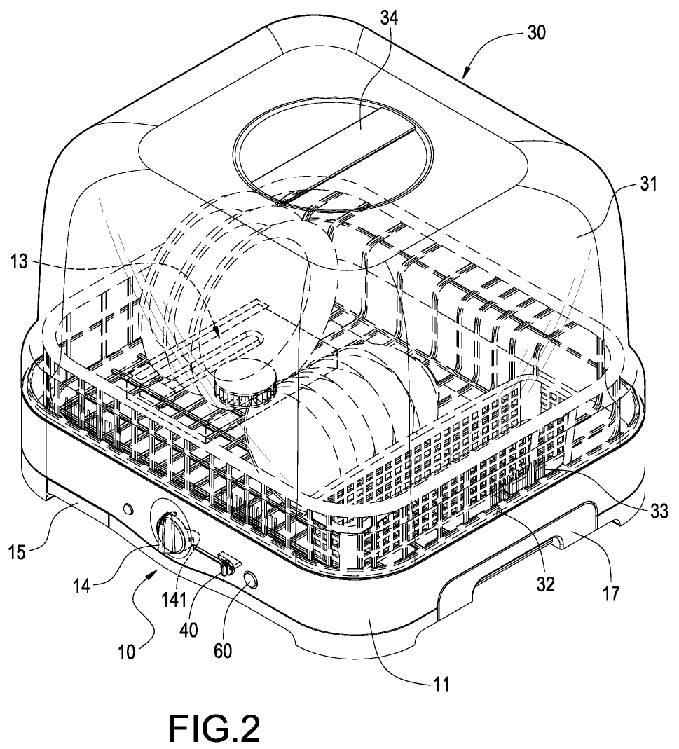

Please refer to FIG. 2, which is a view showing the operating state of the present invention in drying dishes. The dishes after washing are put in the tableware basket 50. Then, the cover 30 covers the dish-drying body 10. The switching element 40 is operated to electrically connect the dish-drying body 10 and the circuit board 12, and then the countdown time of the timer 14 is set. Since the rotation 141 of the cam structure 141 will not be restricted, the timer 14 can be set arbitrarily, and usually it takes about one hour to dry the dishes. The switch 60 is turned on to electrically connect the circuit board 12 and the external power supply, thereby activating the hot air generator 13. The heating element 131 heats up the surrounding air, and the fan 132 blows the hot air through the air-exiting port and the hot air port 111 into the accommodating space 31. The hot air is circulated in the accommodating space 31 to dry the dishes. The wetted air is exhausted through the exhausting holes 33. After the countdown time of the timer 14 is finished, the hot air generator 13 stops working. The user can watch the drying condition through the transparent cover 30. If the water droplets on the dishes are not dried completely, the user resets the timer 14 to continue the operation of the hot air generator 13. When the dishes are dried completely, the user grips the handle 34 to take off the cover 30 and take the dried dishes out of the machine. The water droplets of the dishes will be collected to the supporting tray 15 through the filtering holes 51 and the opened drainage valve 16. The supporting tray 15 can be drawn out to remove the accumulated water.

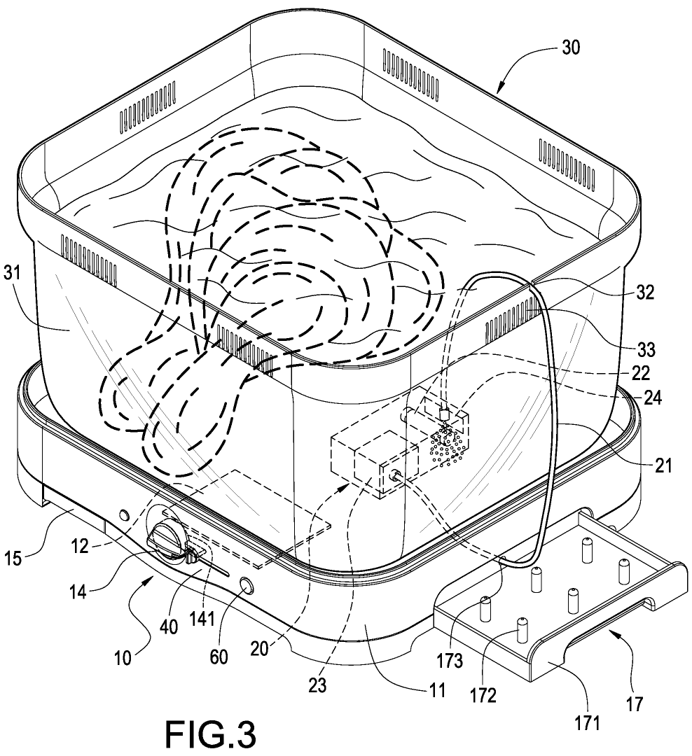

Please refer to FIG. 3, which is a schematic view showing the operating state of the present invention in cleaning vegetables and fruits. First, the tableware basket 50 is removed from the dish-drying body 10. The cover 30 is turned upside down to cover the dish-drying body 10, and fresh water is filled in the accommodating space 31. The vegetables and fruits to be cleaned are put into the fresh water. The level of the fresh water is not higher than that of the insertion hole 32 and the exhausting holes 33, thereby avoiding from the overflowing of the water to damage the dish-drying body 10. The plate 171 is drawn out and the air-delivering pipe 21 is unwound from the posts 172. One end of the air-delivering pipe 21 penetrates the insertion hole 32 into the water of the accommodating space 31. The switching element 40 is operated to electrically connect the ozone generator 20 and the circuit board 12. Since the switching element 40 will restrict the rotation of the cam structure 141, the timer 14 can be set to a certain value only. Since it would be better to execute the ozone cleaning without exceeding fifteen minutes, the timer 14 is set at most to fifteen minutes. If the timer 14 is originally set to over fifteen minutes, the switching element 40 will be restricted by the cam structure 141, so that it cannot be switched to the ozone cleaning function. Then, the switch 60 is turned on to electrically connect the circuit board 12 and the external power source, thereby activating the operation of the ozone generator 20. At this time, the ultraviolet lamp 22 illuminates the surrounding air. With a wavelength in a range of 175 nm to 200 nm, the oxygen molecules in the air will be ionized to form ozone. The formula of ozone is O₃ with a molecular weight of 48, a melting point of 192.7° C., boiling point of −111.9° C. The ozone is slightly dissolvable in the water. The specific weight of ozone is approximately 1.7 times of the air and 1.5 times of the oxygen. The thin ozone has no color and smell and is a nonflammable gas. Low concentration of ozone generates a special smell of grass, while high concentration of ozone exhibits a light blue. In normal temperature between 18° C. and 30° C., ozone will be decomposed into oxygen molecules and oxygen atoms. The chemical property of the oxygen atoms is very active to generate strong sterilizing, deodorizing, and bleaching effects, thereby preventing the propagation of bacteria and mildew. The cylinder 23 drives the ozone into the water through the air-delivering pipe 21. The air is introduced through the venting hole 24 into the ozone generator 20 to generate more ozone. The ozone is dissolved in the water to remove the sweat dirt, inset eggs and remaining pesticide on the surface of vegetables and fruits.

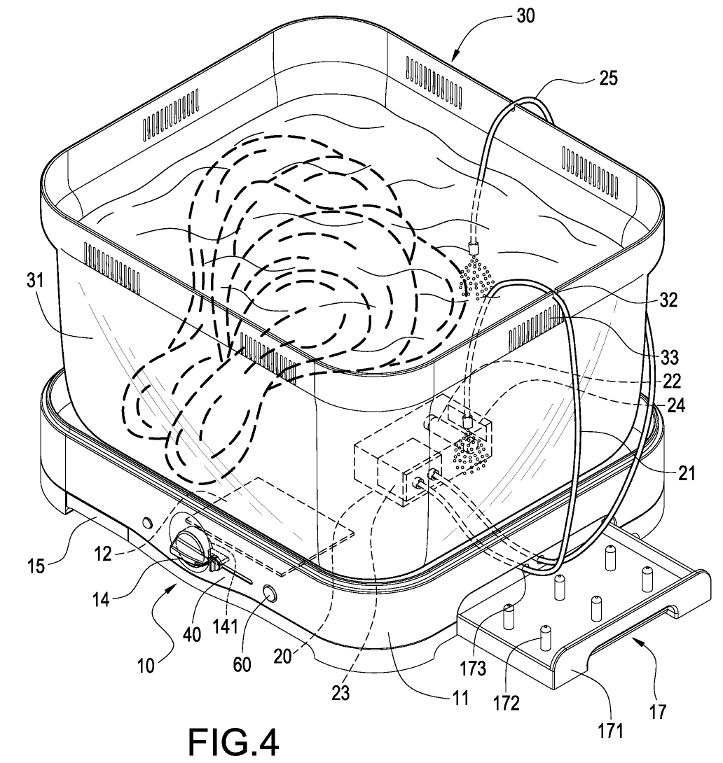

Please refer to FIG. 4, which shows the introduction of ozone by a plurality of pipes. The composite machine for drying dishes and cleaning vegetables and fruits further includes an auxiliary air-delivering pipe 25. One end of the auxiliary air-delivering pipe 25 is connected to the cylinder 23. The other end of the air-delivering pipe 21 is received in the storage portion 17. In use, the air-delivering pipe 21 extends into the water, and the auxiliary air-delivering pipe 25 extends into the water to be away from the air-delivering pipe 21. In this way, the amount and range of ozone dissolved in the water can be increased, so that the effect of cleaning vegetables and fruits can be enhanced.

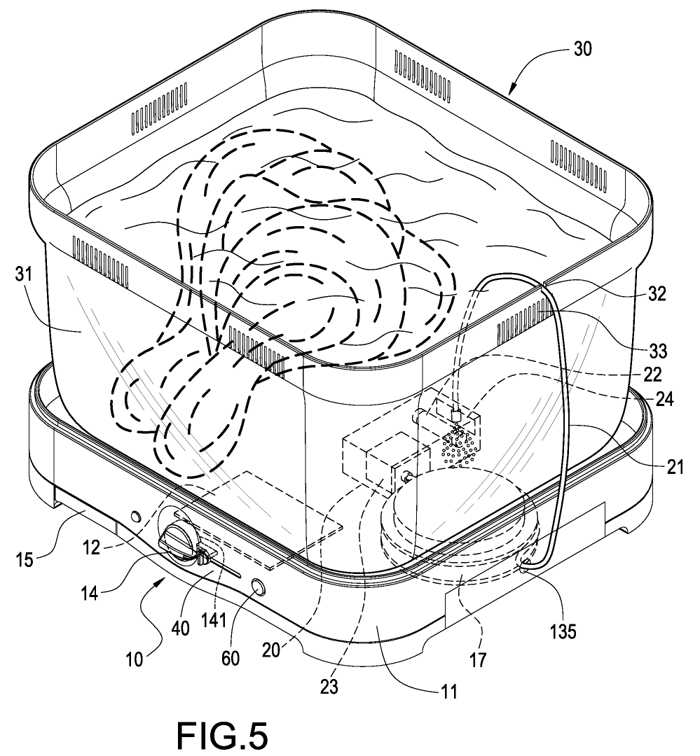

Please refer to FIG. 5, which is a view showing the storage of the air-delivering pipe according to another embodiment of the present invention. The storage portion 17 is fixed in the base 11. The side wall of the base 11 is provided with a through-hole 135 to correspond to the position of the storage portion 17. The storage portion 17 is a winding disk. One end of the air-delivering pipe 21 is connected to the cylinder 23, and the other end thereof is received in the storage portion 17 to penetrate the through-hole 135. In use, the air-delivering pipe 21 penetrates the through-hole 135 to be drawn out of the storage portion 17. Then, the air-delivering pipe 21 is inserted into the insertion hole 32 and thus extends into the water. After using, the air-delivering pipe 21 is wounded into the storage portion 17 with its distal end protruding from the through-hole 135 for subsequent use.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A composite machine for drying dishes and cleaning vegetables and fruits, comprising:
a dish-drying body;
an ozone generator mounted in the dish-drying body, the ozone generator having an air-delivering pipe; and
a cover selectively covering the dishes or allowing the vegetables and fruits to be received therein, one end of the air-delivering pipe being disposed in the cover.

2. The composite machine for drying dishes and cleaning vegetables and fruits according to claim 1, wherein the dish-drying body comprises a base, a supporting tray provided in the base, and a drainage valve provided in the base to correspond to the supporting tray.

3. The composite machine for drying dishes and cleaning vegetables and fruits according to claim 1, wherein the cover is provided with an insertion hole for allowing the air-delivering pipe to penetrate.

4. The composite machine for drying dishes and cleaning vegetables and fruits according to claim 1, further comprising a tableware basket provided in the dish-drying body.

5. The composite machine for drying dishes and cleaning vegetables and fruits according to claim 1, wherein the dish-drying body comprises a base, a hot air generator fixed in the base, and a storage portion provided in the base for receiving the air-delivering pipe.

6. The composite machine for drying dishes and cleaning vegetables and fruits according to claim 5, wherein the storage portion comprises a plate and a plurality of posts protruding from the surface of the plate, the storage portion is provided with a guiding hole at one side corresponding to the ozone generator, and the air-delivering pipe penetrates the guiding hole to be wound around the posts.

7. The composite machine for drying dishes and cleaning vegetables and fruits according to claim 5, wherein the storage portion is a winding disk, a side wall of the base is provided with a through-hole to correspond to the storage portion, and the air-delivering pipe is wound in the winding disk with its end penetrating the through-hole.

8. The composite machine for drying dishes and cleaning vegetables and fruits according to claim 5, wherein the base is provided with a hot air port at a position corresponding to the hot air generator.

9. The composite machine for drying dishes and cleaning vegetables and fruits according to claim 5, wherein the dish-drying body further comprises a timer electrically connected to the hot air generator.

10. A composite machine for drying dishes and cleaning vegetables and fruits, comprising;
a dish-drying body;
an ozone generator mounted in the dish-drying body, the ozone generator having an air-delivering pipe;
a cover selectively covering the dishes or allowing the vegetables and fruits to be received therein, one end of the air-delivering pipe being disposed in the cover; and
a switching element fixed in the dish-drying body and switchable to be electrically connected to the dish-drying body or the ozone generator,
wherein the dish-drying body generates hot air to dry the dishes when the switching element is electrically connected to the dish-drying body, and the ozone generator generates ozone to clean the vegetables and fruits when the switching element is electrically connected to the ozone generator.

11. The composite machine for drying dishes and cleaning vegetables and fruits according to claim 10, wherein the dish-drying body comprises a base, a supporting tray provided in the base, and a drainage valve provided in the base to correspond to the supporting tray.

12. The composite machine for drying dishes and cleaning vegetables and fruits according to claim 10, wherein the cover is provided with an insertion hole for allowing the air-delivering pipe to penetrate.

13. The composite machine for drying dishes and cleaning vegetables and fruits according to claim 10, further comprising a tableware basket provided in the dish-drying body.

14. The composite machine for drying dishes and cleaning vegetables and fruits according to claim 10, wherein the dish-drying body comprises a base, a hot air generator fixed in the base, and a storage portion provided in the base for receiving the air-delivering pipe.

15. The composite machine for drying dishes and cleaning vegetables and fruits according to claim 14, wherein the storage portion comprises a plate and a plurality of posts protruding from the surface of the plate, the storage portion is provided with a guiding hole at one side corresponding to the ozone generator, and the air-delivering pipe penetrates the guiding hole to be wound around the posts.

16. The composite machine for drying dishes and cleaning vegetables and fruits according to claim 14, wherein the storage portion is a winding disk, a side wall of the base is provided with a through-hole to correspond to the storage portion, and the air-delivering pipe is wound in the winding disk with its end penetrating the through-hole.

17. The composite machine for drying dishes and cleaning vegetables and fruits according to claim 14, wherein the base is provided with a hot air port at a position corresponding to the hot air generator.

18. The composite machine for drying dishes and cleaning vegetables and fruits according to claim 14, wherein the dish-drying body further comprises a timer electrically connected to the hot air generator.

19. The composite machine for drying dishes and cleaning vegetables and fruits according to claim 18, wherein the timer comprises a cam structure for cooperating with the switching element.
